(19) United States
(12) Patent Application Publication
(10) Pub. No.: US 2013/0076007 A1
(43) Pub. Date: Mar. 28, 2013

(54) VEHICLE BACKUP CAMERA FOR VIEWING A MID-CHASSIS MOUNTED TRAILER HITCHING STRUCTURE

(71) Applicants: Joseph Goode, Northville, MI (US); Kirk Andrew Parrish, Grass Lake, MI (US)

(72) Inventors: Joseph Goode, Northville, MI (US); Kirk Andrew Parrish, Grass Lake, MI (US)

(21) Appl. No.: 13/245,915

(22) Filed: Sep. 27, 2011

(51) Int. Cl. H04N 7/18; F21V 19/00; F21S 8/10; B60D 1/00

(52) U.S. Cl. 280/504; 348/148; 362/549; 362/485; 348/E07.085

(57) ABSTRACT

A pick-up truck comprises a chassis, a rear axle attached to the chassis, a passenger cabin, a cargo bed, a trailer hitching structure, and a first image capturing device. The passenger cabin is attached to the chassis forward of the rear axle. The cargo bed is attached to the chassis over the rear axle. The trailer hitching structure is attached to the chassis at a position rearward of the vehicle occupant structure and has a trailer engaging portion accessible within the cargo bed. The first image capturing device is attached to the passenger cabin. The first image capturing device is mounted in a manner allowing the first image capturing device to capture an image of the trailer engaging portion of the trailer hitching structure.

### FIELD OF THE DISCLOSURE

The disclosures made herein relate generally to vehicle backup cameras and, more particularly, to a vehicle backup camera for viewing a mid-chassis mounted trailer hitching structure.

### BACKGROUND

A gooseneck trailer hitch and a fifth (5^{th}) wheel trailer hitch are two examples of mid-chassis mounted trailer hitching structures. The term mid-chassis in the context of the disclosure made herein refers to a location that is above and, preferably, forward of a rear axle of a vehicle. In contrast to a bumper/rear mounted trailer hitching structure, examples of benefits of a mid-chassis mounted trailer hitching structure include, but are not limited to, enhanced weight distribution due to the down load at the hitch being over or in front of a rear axle of the vehicle and better vehicle-trailer maneuverability due to the pivot point of the trailer being located close to the front wheels. The gooseneck trailer hitch and the 5^{th} wheel trailer hitch both have a vehicle-mounted trailer hitching structure (i.e., a mid-chassis mounted trailer hitching structure) and a trailer-mounted trailer hitching structure that is configured for being coupled to the vehicle-mounted trailer hitching structure. A pick-up truck and a chassis cab truck are two examples of vehicles on which mid-chassis mounted trailer hitching structures are commonly mounted.

For any number of reasons, backing a vehicle to align the vehicle-mounted trailer hitching structure to the trailer-mounted trailer hitching structure can be a difficult task for many drivers. In the case of a trailer that is connected to a hitch at the rear of a pick-up truck (e.g., a bumper-mounted trailer hitching structure), one known solution includes the use of a backup camera integrated into a tailgate of the pick-up truck. An image provided by the tailgate-mounted back-up camera is used for visually monitoring alignment of the vehicle-mounted trailer hitching structure and the trailer-mounted trailer hitching structure during backing of the vehicle. While a tailgate-mounted back-up camera works well for such trailer alignment viewing with vehicle-mounted trailer hitching structure that is at the rear of the vehicle, such a tailgate-mounted back-up camera does not provide such usefulness with a mid-chassis mounted trailer hitching structure because the mid-chassis mounted trailer hitching structures is located forward of a field of view of the tailgate mounted backup camera.

Therefore, a camera that allows for viewing of alignment of a trailer-mounted trailer hitching structure with a mid-chassis mounted trailer hitching structure of a vehicle during backing of the vehicle toward the trailer would be advantageous, desirable and useful.

### SUMMARY OF THE DISCLOSURE

Embodiments of the present invention are directed to using a camera (i.e., an image capturing device) to aid in connecting a trailer to a mid-chassis mounted trailer hitching structure of a vehicle. More specifically, embodiments of the present invention utilize a camera attached to the vehicle forward of the mid-chassis mounted trailer hitching structure for viewing of alignment of a trailer-mounted trailer hitching structure with the mid-chassis mounted trailer hitching structure of the vehicle during backing of the vehicle toward the trailer. In doing so, embodiments of the present invention advantageously overcome one or more limitations associated with conventional approaches for using a camera to aid in connecting a trailer to trailer hitching structure of a vehicle. In overcoming such limitations, a key benefit of a camera-based vehicle back-up aid as disclosed herein is improved customer efficiency and satisfaction resulting from less time to hook up to 5^{th} wheel and gooseneck type trailers.

In one embodiment of the present invention, a vehicle comprises a chassis, a vehicle occupant structure, a trailer hitching structure, and a first image capturing device. The vehicle occupant structure is attached to the chassis. The trailer hitching structure is attached to the chassis and has a trailer engaging portion located at a position rearward of the vehicle occupant structure. The first image capturing device is attached to the vehicle occupant structure. The image capturing device is mounted in a manner allowing the first image capturing device to capture an image of the trailer engaging portion of the trailer hitching structure.

In another embodiment of the present invention, a pick-up truck comprises a chassis, a rear axle attached to the chassis, a passenger cabin, a cargo bed, a trailer hitching structure, and a first image capturing device. The passenger cabin is attached to the chassis forward of the rear axle. The cargo bed is attached to the chassis over the rear axle. The trailer hitching structure is attached to the chassis at a position rearward of the vehicle occupant structure and has a trailer engaging portion accessible within the cargo bed. The first image capturing device is attached to the passenger cabin. The first image capturing device is mounted in a manner allowing the first image capturing device to capture an image of the trailer engaging portion of the trailer hitching structure.

In another embodiment of the present invention, a vehicle comprises a passenger cabin and a cargo light assembly attached to the passenger cabin. The cargo light assembly includes an illumination device and a first image capturing device. The first image capturing device has a field of view including a space rearward of the passenger cabin.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a perspective view showing a pick-up truck configured in accordance with an embodiment of the present invention.

FIG. 2 is fragmentary view showing a carbo light assembly configured in accordance with an embodiment of the present invention.

FIG. 3 is a block diagram showing an information processing architecture configured in accordance with an embodiment of the present invention.

### DETAILED DESCRIPTION OF THE DRAWING FIGURES

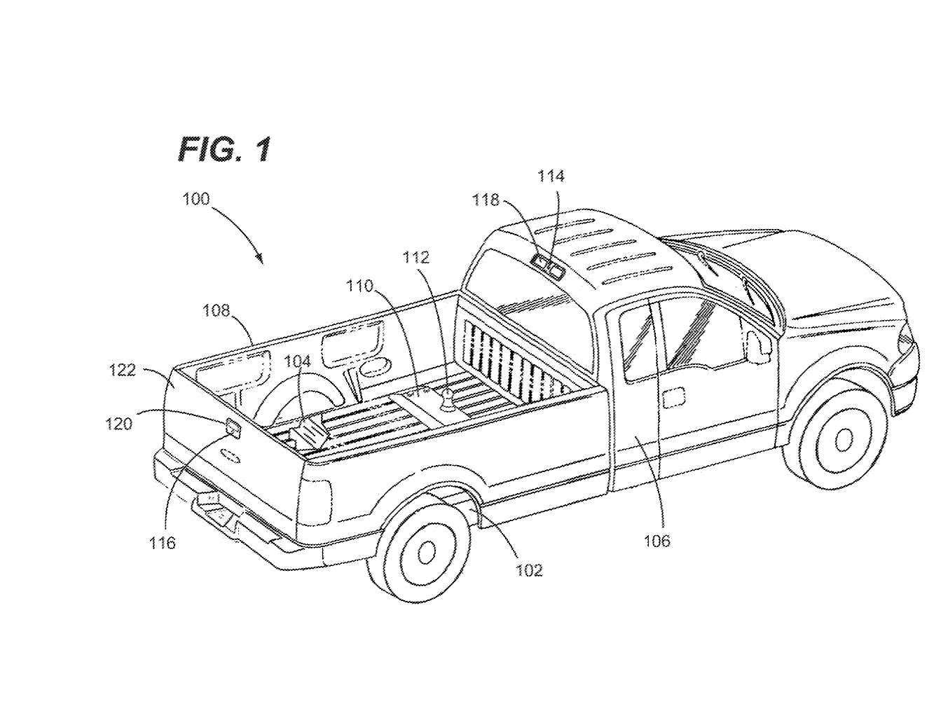

FIG. 1 shows pick-up truck 100 configured in accordance with an embodiment of the present invention. The pick-up truck 100 includes a chassis 102, a rear axle 104, a passenger cabin 106 (i.e., a vehicle occupant structure), and a cargo bed 108. It is disclosed herein that a vehicle configured in accordance with the present invention can have a plurality of rear axles with respect to an axle at the front of the vehicle. The rear axle 104, the passenger cabin 106, and the cargo bed 108 are attached to the chassis 102. As can be seen, the passenger cabin 106 is positioned forward of the rear axle 104 and the cargo bed 108 is attached to the chassis 102 over the rear axle 104. However, it is disclosed herein that the passenger cabin 106 and/or the cargo bed 108 can be configured with a uni-body (i.e., unitary body) construction, such uni-body construction approach being well known in the relevant art(s). A chassis cab truck is another variant of a vehicle that can be configured in accordance with an embodiment of the present invention.

The pick-up truck 100 has a trailer hitching structure 110 mounted thereon (i.e., a vehicle-mounted trailer hitching structure). Preferably, the trailer hitching structure 110 is attached to the chassis 102 such as via threaded fasteners. The trailer hitching structure 110 is mounted forward of the rear axle 104 thereby making it a mid-chassis mounted trailer hitching structure. As discussed above, the term mid-chassis in the context of the disclosure made herein refers to a location of a trailer hitching structure (e.g., the trailer hitching structure 110) that is above and, preferably, forward of a rear axle (e.g., the axle 104) of a vehicle (e.g., the vehicle 100). It should also be understood that the trailer hitching structure 110 is depicted as being a gooseneck trailer hitching structure having a ball 112 that is engaged with a mating structure of a trailer-mounted trailer hitching structure (i.e., a coupler). In this regard, the ball 112 is a trailer engaging portion of the trailer hitching structure 110. Alternatively, the trailer hitching structure 110 can be provided in the form of a fifth (5^{th}) wheel trailer hitching structure (i.e., a coupler) that engages a mating trailer-mounted trailer hitching structure (e.g., a kingpin). It is disclosed herein that a gooseneck trailer hitching structure and a fifth (5^{th}) wheel trailer hitching structure are two examples of mid-chassis mounted trailer hitching structures.

The vehicle 100 includes a first camera 114 and a second camera 116. The first camera 114 is integral with a cargo light assembly 118, which is attached to the passenger cabin 106 of the vehicle 100. The second camera 116 is integral with a tailgate latch assembly 120, which is attached to a tailgate 122 of the vehicle 100. In this regard, the first camera 114 is attached to the passenger cabin 106 and the second camera 116 is attached to the tailgate 122. The first camera 114 is mounted in a manner allowing it to capture an image of the ball 112 of the trailer hitching structure 110. As such, the first camera has a field of view including a space rearward of the passenger cabin 106 and the ball 112 is within that field of view. In an embodiment where the trailer hitching structure 110 was configured in accordance with a 5^{th} wheel trailer hitching structure, the first camera 114 would be mounted in a manner allowing it to capture an image of the coupler of such 5^{th} wheel hitching structure.

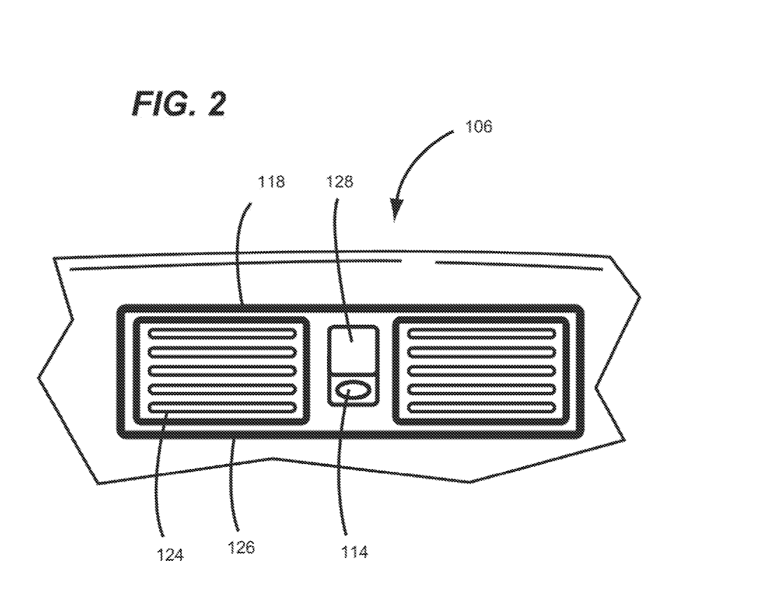

Referring now to FIGS. 1 and 2, the cargo light assembly 118 includes at least one light 124 (i.e., an illumination device). As shown, the first camera 114 and the light 124 are both integral with a housing structure 126 of the cargo light assembly 118. The first camera 114 can be attached to the housing structure 126 through a camera mount 128 that is shaped and/or oriented to cause the first camera 114 to have a desired field of view.

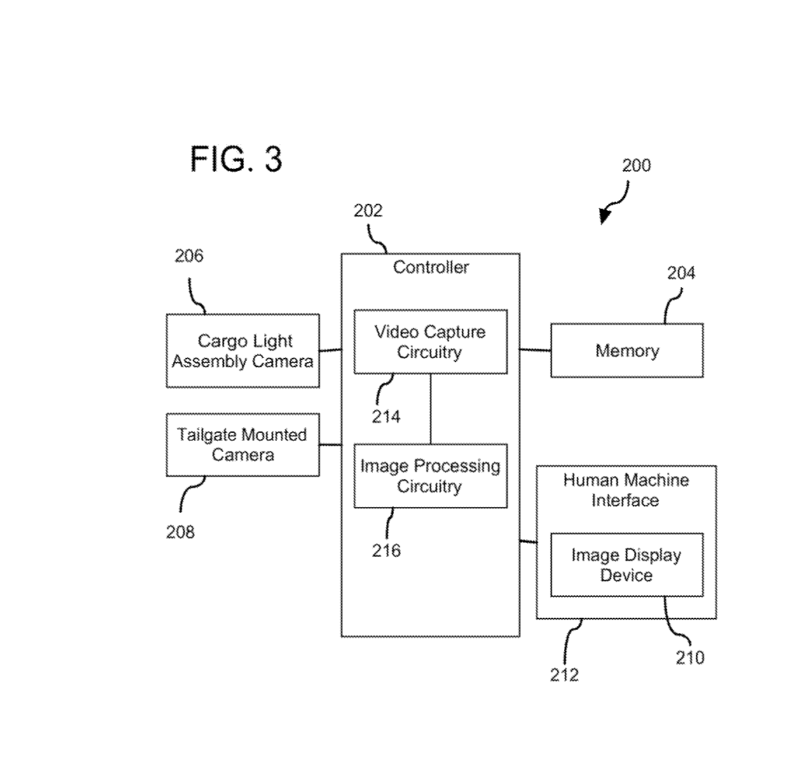

FIG. 3 shows an information processing architecture 200 configured in accordance with an embodiment of the present invention. The information processing architecture 200 provides for camera image viewing functionality in accordance with the present invention. Preferably, but not necessarily, such viewing is provided in real-time (e.g., as a video image) as a vehicle into which the information processing architecture 200 is integrated is being backed toward a trailer for the purpose of allowing a trailer-mounted trailer hitching structure to be coupled to a trailer hitching structure of the vehicle.

The information processing architecture 200 includes a controller 202, memory 204, a cargo light assembly camera 206, a tailgate mounted camera 208, and a human machine interface 210. The controller 202 is coupled between the memory 204, the cargo light assembly camera 206, the tailgate mounted camera 208, and the human machine interface 210, thereby allowing transmission of information (e.g., respective signals) therebetween. Such transmission of information can be conducted digitally over a controller area network (CAN) of a vehicle (e.g., the vehicle 100) such as, for example, in conjunction with a body control module (BCM) that regulates control of information communication. A driver instrument cluster, steering wheel control module, rear view mirror display, and a navigation system user interface are examples of the human machine interface 210.

The controller 202 is preferably a microprocessor-based controller having a central processing unit, internal memory such as random access memory (RAM) or read only memory (ROM), and associated inputs and outputs communicating across a bus. The controller 202 can be a portion of a central vehicle main control unit or stand-alone unit. The memory 204 can comprise various types of memory including, but not limited to, ROM, RAM, electrically erasable programmable read only memory (ePROM), and keep alive memory. Memory 204 is used to store various instructions, data, and the like. It is disclosed that the memory 204 can be omitted and memory of the controller 202 can be used for storing such instructions, data, and the like.

The controller 202 can include various circuitry as necessary to process signals from the cameras 206, 208 and to cause a corresponding image (e.g., video image) to be displayed on an. image display device 212 of the human machine interface 210. A visual display (e.g., a liquid crystal display (LCD) screen) of a driver side mirror, a rear view mirror, a driver instrument cluster, a navigation system, etc is an example of the image display device 212. As depicted in FIG. 3, the controller 202 includes video capture circuitry 214 and image processing circuitry 216 coupled to the video capture circuitry 214. The cargo light assembly camera 206 and the tailgate mounted camera 208 are both coupled to the controller for allowing signals therefrom to be provided to the video capture circuitry 214. The video capture circuitry 214 uses these signals to create a respective image signal that is processed by the image processing circuitry for output to the image display device 212. In an alternate embodiment, such video capture functionality and/or image processing functionality is provided through circuitry of a respective one of the cameras 206, 208. It is disclosed herein that the human machine interface 210 can be configured to allow for image display (i.e., visual output) to be selectively switched between an image captured by the cargo light assembly camera 206 and an image captured by the tailgate mounted camera 208. It is also disclosed herein that the cargo light assembly camera 206 and the tailgate mounted camera 208 can each be implemented as any number of different types of camera configuration such as, for example, a complementary metal oxide semiconductor (CMOS) type camera or a charge coupled device (CCD) type camera.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A vehicle, comprising:
a chassis,
a vehicle occupant structure attached to the chassis;
a trailer hitching structure attached to the chassis and having a trailer engaging portion located at a position rearward of the vehicle occupant structure; and
a first image capturing device attached to the vehicle occupant structure, wherein the image capturing device is mounted in a manner allowing the first image capturing device to capture an image of the trailer engaging portion of the trailer hitching structure.

2. The vehicle of claim 1 wherein:
the vehicle occupant structure includes a rearward facing portion;
the first image capturing device is located on the rearward facing portion of the vehicle occupant structure; and
the rearward facing portion is located forward of the trailer engaging portion of the trailer hitching structure.

3. The vehicle of claim 1, further comprising:
a cargo light assembly attached to the vehicle occupant structure, wherein the first image capturing device is integral with the cargo light assembly.

4. The vehicle of claim 3 wherein:
the vehicle occupant structure includes a rearward facing portion;
the cargo light assembly is located on the rearward facing portion of the vehicle occupant structure; and
the rearward facing portion is located forward of the trailer engaging portion of the trailer hitching structure.

5. The vehicle of claim 1, further comprising:
an image displaying device coupled to the image capturing device, wherein images captured by the first image capturing device are displayable on the image displaying device.

6. The vehicle of claim 5, further comprising:
a second image capturing device provided on the vehicle at a distal location with respect to the first image capturing device, wherein the image displaying device is coupled to the second image capturing device and wherein images captured by the second image capturing device are displayable on the image displaying device; and
a switching device coupled to the first and second image capturing devices, wherein the switching device allows images captured by the first image capturing device and images captured by the second image capturing device to be selectively displayed on the image displaying device.

7. The vehicle of claim 6, further comprising:
a cargo light assembly attached to the vehicle occupant structure, wherein the first image capturing device is integral with the cargo light assembly.

8. The vehicle of claim 7 wherein:
the vehicle occupant structure includes a rearward facing portion;
the cargo light assembly is located on the rearward facing portion of the vehicle occupant structure; and
the rearward facing portion is located forward of the trailer engaging portion of the trailer hitching structure.

9. A pick-up truck, comprising:
a chassis;
a rear axle attached to the chassis;
a passenger cabin attached to the chassis forward of the rear axle;
a cargo bed attached to the chassis over the rear axle;
a trailer hitching structure attached to the chassis at a position rearward of the vehicle occupant structure and having a trailer engaging portion accessible within the cargo bed; and
a first image capturing device attached to the passenger cabin, wherein the first image capturing device is mounted in a manner allowing the first image capturing device to capture an image of the trailer engaging portion of the trailer hitching structure.

10. The pick-up truck of claim 9 wherein:
the passenger cabin includes a rearward facing portion;
the first image capturing device is located on the rearward facing portion of the vehicle occupant structure; and
the rearward facing portion is located forward of the rear axle.

11. The pick-up truck of claim 9, further comprising:
a cargo light assembly attached to the passenger cabin, wherein the first image capturing device is integral with the cargo light assembly.

12. The pick-up truck of claim 11 wherein:
the passenger cabin includes a rearward facing portion;
the cargo light assembly is located on the rearward facing portion of the passenger cabin; and
the rearward facing portion is located forward of the rear axle.

13. The pick-up truck of claim 9, further comprising:
an image displaying device coupled to the image capturing device, wherein images captured by the first image capturing device are displayable on the image displaying device.

14. The pick-up truck of claim 13, further comprising:
a second image capturing device provided on the vehicle at a distal location with respect to the first image capturing device, wherein the image displaying device is coupled to the second image capturing device and wherein images captured by the second image capturing device are displayable on the image displaying device; and
a switching device coupled to the first and second image capturing devices, wherein the switching device allows images captured by the first image capturing device and images captured by the second image capturing device to be selectively displayed on the image displaying device.

15. The pick-up truck of claim 14, further comprising:
a cargo light assembly attached to the passenger cabin, wherein the first image capturing device is integral with the cargo light assembly, wherein the passenger cabin includes a rearward facing portion, wherein the cargo light assembly is located on the rearward facing portion of the passenger cabin, and wherein the rearward facing portion is located forward of the rear axle.

16. A vehicle, comprising:
a passenger cabin; and
a cargo light assembly attached to the passenger cabin, wherein the cargo light assembly includes an illumination device and a first image capturing device and wherein the first image capturing device has a field of view including a space rearward of the passenger cabin.

17. The vehicle of claim 16, further comprising:
a cargo bed attached to the chassis rearward of the passenger cab; and
a trailer hitching structure attached to the chassis at a position rearward of the passenger cabin and having a trailer engaging portion accessible within the cargo bed, wherein the trailer engaging portion is within the field of view of the first image capturing device.

18. The vehicle of claim 17 wherein:
the passenger cabin includes a rearward facing portion; and
the cargo light assembly is located on the rearward facing portion of the passenger cabin.

19. The vehicle of claim 16, further comprising:
an image displaying device coupled to the image capturing device, wherein images captured by the first image capturing device are displayable on the image displaying device;
a second image capturing device provided on the vehicle at a distal location with respect to the first image capturing device, wherein the image displaying device is coupled to the second image capturing device and wherein images captured by the second image capturing device are displayable on the image displaying device; and
a switching device coupled to the first and second image capturing devices, wherein the switching device allows images captured by the first image capturing device and images captured by the second image capturing device to be selectively displayed on the image displaying device.

20. The vehicle of claim 19, further comprising:
a cargo bed attached to the chassis rearward of the passenger cab; and
a trailer hitching structure attached to the chassis at a position rearward of the passenger cabin and having a trailer engaging portion accessible within the cargo bed, wherein the trailer engaging portion is within the field of view of the first image capturing device.
